(19) United States
(12) Patent Application Publication
(10) Pub. No.: US 2025/0018581 A1
(43) Pub. Date: Jan. 16, 2025

(54) FORCE INFORMATION DISPLAY DEVICE

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 18/741,012

(22) Filed: Jun. 12, 2024

(30) Foreign Application Priority Data
Jul. 12, 2023 (JP) 2023-114721

(51) Int. Cl. B25J 13/06; B25J 19/02; G01L 1/26; G01L 5/22; G06F 3/14

(52) U.S. Cl. CPC B25J 13/06; B25J 19/02; G01L 1/26; G01L 5/226; G06F 3/14

(57) ABSTRACT

A control section executes: a first calculation process calculating, from an angular velocity supplied from a gyro sensor, a displaced angle of a robot hand; a first display process converting, according to the displaced angle of the robot hand, at least one of a force and a moment, supplied from the force sensor, in a force sensor coordinate system fixed to a force sensor into at least one of a force and a moment in an absolute coordinate system fixed to a ground and indicating it on a display; or a second display process indicating, on the display, a relation between the absolute coordinate system and the force sensor coordinate system according to the displaced angle of the robot hand.

This Nonprovisional application claims priority under 35 U.S.C. § 119 on Patent Application No. 2023-114721 filed in Japan on Jul. 12, 2023, the entire contents of which are hereby incorporated by reference.

### TECHNICAL FIELD

The present invention relates to a force information display device that displays force information detected by a force sensor.

### BACKGROUND ART

Patent Literature 1 discloses a finishing robot for which direct teaching can be carried out. The finishing robot includes a robot arm having a distal end to which a work piece to be finished can be attached via a joint part. Patent Literature 1 also states that a force sensor is attached between the robot arm and the joint part.

### CITATION LIST

### Patent Literature

[Patent Literature 1] Japanese Patent Application Publication, Tokukai, No. 2023-44449

### SUMMARY OF INVENTION

### Technical Problem

In a case where at least one of a force and a moment applied to the force sensor attached to such a robot arm is monitored, a coordinate axis of a force sensor coordinate system fixed to the force sensor is inclined with respect to a coordinate axis of an absolute coordinate system fixed to a ground. Therefore, the force and the moment, applied to the force sensor, in the force sensor coordinate system differ from a force and a moment in the absolute coordinate system, and thus it is difficult for a work person to acknowledge the force and the moment, applied to the work piece, in the absolute coordinate system, disadvantageously.

An aspect of the present invention was made in view of the above problem, and has an object to provide a force information display device that allows a work person to easily acknowledge at least one of a force and a moment, applied to a work piece, in an absolute coordinate system.

### Solution to Problem

In order to attain the above object, a force information display device in accordance with an aspect of the present invention includes: a signal input section that receives detection signals respectively supplied from a force sensor and a gyro sensor disposed between a robot arm and a robot hand; and a control section, the control section executing a first calculation process and a first display process or a second display process, the first calculation process calculating a displaced angle of the robot hand from an angular velocity supplied from the gyro sensor via the signal input section, the first display process (a) carrying out, on a basis of the displaced angle of the robot hand calculated in the first calculation process, conversion such that at least one of a force and a moment in a force sensor coordinate system fixed to the force sensor, supplied from the force sensor via the signal input section, is converted into at least one of a force and a moment in an absolute coordinate system fixed to a ground and (b) indicating a result of the conversion on a display, and the second display process indicating, on the display, a relation between the absolute coordinate system and the force sensor coordinate system on a basis of the displaced angle of the robot hand calculated in the first calculation process.

### Advantageous Effects of Invention

In accordance with an aspect of the present invention, the display indicates (i) at least one of the force and the moment in the absolute coordinate system or (ii) the relation between the absolute coordinate system and the force sensor coordinate system. Thus, a work person can easily acknowledge at least one of the force and the moment, applied to the work piece, in the absolute coordinate system.

### BRIEF DESCRIPTION OF DRAWINGS

FIG. 1 is a view schematically illustrating an example of a configuration of a force information display system in accordance with a first embodiment.

FIG. 2 is a block diagram illustrating an example of an electrical configuration of the force information display device in accordance with the first embodiment.

FIG. 3 is a flowchart illustrating an example of a first force information display process executed by a control section in accordance with the first embodiment.

FIG. 4 is a view illustrating an example of a display screen indicated on a display of the force information display device in accordance with the first embodiment.

FIG. 5 is a flowchart illustrating an example of a second force information display process executed by the control section in accordance with a second embodiment.

FIG. 6 is a view illustrating an example of a display screen indicated on the display of the force information display device in accordance with the second embodiment.

### DESCRIPTION OF EMBODIMENTS

The following will describe, with reference to the drawings, details of a first embodiment and a second embodiment in each of which the present invention is implemented. The same or similar constituent elements, members, and processes depicted in the drawings are given the same reference numerals, and the same descriptions are omitted as appropriate.

### First Embodiment

### [Schematic Configuration of Force Information Display System 100]

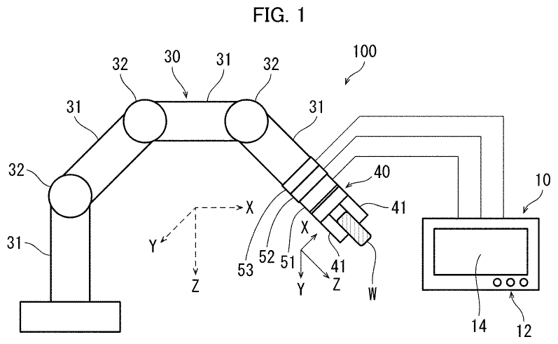

First, the following description will schematically discuss, with reference to FIG. 1, a configuration of a force information display system 100 in accordance with the first embodiment of the present disclosure. FIG. 1 is a view schematically illustrating an example of a configuration of the force information display system 100 in accordance with the first embodiment. As shown in FIG. 1, the force information display system 100 includes a force information display device 10, a robot arm 30, a robot hand 40, a force sensor 51, a triaxial acceleration sensor 52, and a triaxial gyro sensor 53. Note that the robot arm 30 is configured such that the robot arm 30 can be subjected to teaching through, e.g., direct teaching or online teaching.

### [Schematic Configuration of Robot Arm 30]

The robot arm 30 is an articulated arm including a plurality of arms 31. In the robot arm 30, four arms 31 are connected by three joints 32. However, the number of arms 31 included in the robot arm 30 is not limited to four. The number of joints 32 connecting the arms 31 is also not limited to three.

The robot hand 40 is configured to be capable of holding a work piece W with two claws 41 which are openable and closable by an actuator (not illustrated). The robot hand 40 is attached to the robot arm 30 via the force sensor 51, the triaxial acceleration sensor 52, and the triaxial gyro sensor 53. The robot arm 30 has six degrees of freedom, and supports the robot hand 40 in such a manner as to allow the robot hand 40 to change its position and its posture.

The force sensor 51 detects directions and magnitudes of a force and a moment applied to the force sensor 51 itself. The force sensor 51 is a six-axis force sensor that detects (i) force components FX, FY, and FZ in directions of three axes, namely, the X-, Y-, and Z-axes of a force sensor coordinate system whose Z-axis direction coincides with an axial direction and (ii) moment components MX, MY, and MZ each being around a rotational axis which is one of the three axes, namely, the X-, Y-, and Z-axes. The force sensor 51 and the robot hand 40 are disposed so as to be coaxial. Here, examples of the three axes, namely, the X-, Y-, and Z-axes of the force sensor coordinate system fixed to the force sensor 51 are indicated by the solid lines in FIG. 1. Further, examples of the three axes, namely, the X-, Y-, and Z-axes of an absolute coordinate system fixed to a ground and whose Z-axis direction coincides with a vertical direction are indicated by the broken lines in FIG. 1.

Thus, the force sensor 51 detects (i) the force components FX, FY, and FZ in the directions of the three axes, namely, the X-, Y-, and Z-axes and (ii) the moment components MX, MY, and MZ each being around a rotational axis which is one of the three axes, namely, the X-, Y-, and Z-axes, the force components FX, FY, and FZ and the moment components MX, MY, and MZ being applied to the robot hand 40. Hereinafter, FX, FY, FZ, MX, MY, and MZ may also be referred to as force components or, simply, detection values. The force sensor 51 outputs, to the force information display device 10, a signal indicative of the detection values.

The triaxial acceleration sensor 52 detects an acceleration applied to the triaxial acceleration sensor 52 itself. The triaxial acceleration sensor 52 is disposed such that its Z-axis direction and the Z-axis f the force sensor 51 are coaxial. The triaxial acceleration sensor 52 detects acceleration components AX, AY, and AZ in the directions of the three axes, namely, the X-, Y-, and Z-axes of the force sensor coordinate system. Hereinafter, AX, AY, and AZ may also be referred to as acceleration components or, simply, detection values. The triaxial acceleration sensor 52 outputs, to the force information display device 10, a signal indicative of the detection values.

The triaxial gyro sensor 53 detects an angular velocity applied to the triaxial gyro sensor 53 itself. The triaxial gyro sensor 53 is disposed such that its Z-axis direction and the Z-axis of the force sensor 51 are coaxial. The triaxial gyro sensor 53 detects angular velocity components WX, WY, and WZ each being around as a rotational axis which is one of the three axes, namely, the X-, Y-, and Z-axes of the force sensor coordinate system. Hereinafter, WX, WY, and WZ may also be referred to as angular velocity components or, simply, detection values. The triaxial gyro sensor 53 outputs, to the force information display device 10, a signal indicative of the detection values.

### [Schematic Configuration of Force Information Display Device 10]

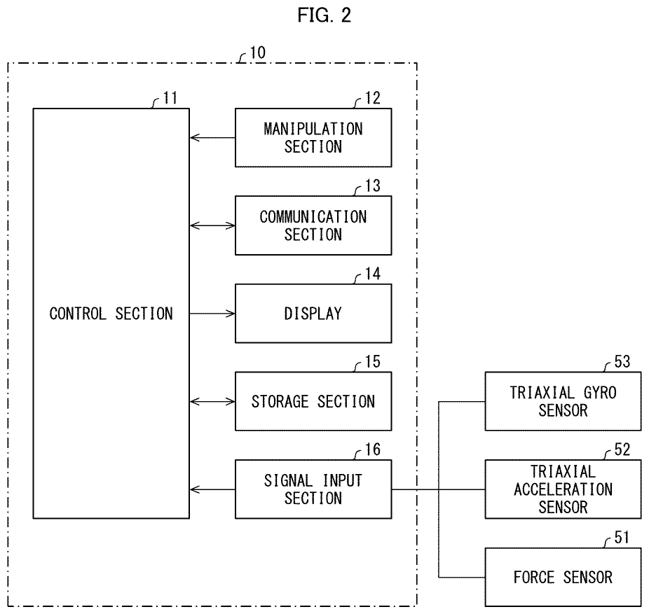

The following will schematically description discuss, with reference to FIGS. 1 and 2, a configuration of the force information display device 10. FIG. 2 is a block diagram illustrating an example of an electrical configuration of the force information display device 10 in accordance with the first embodiment. As shown in FIG. 2, the force information display device 10 includes a control section 11, a manipulation section 12, a communication section 13, a display 14, a storage section 15, and a signal input section 16.

The control section 11 is made of, for example, a central processing unit (CPU). Alternatively, the control section 11 may be made of a graphic processing unit (GPU), a digital signal processor (DSP), a micro processing unit (MPU), a floating point number processing unit (FPU), a physics processing unit (PPU), a microcontroller, or a combination thereof.

The storage section 15 is made of a semiconductor random access memory (RAM), a flash memory, a hard disk drive (HDD), a solid state drive (SSD), an optical disk drive (ODD), or a combination thereof. The control section 11 executes various kinds of computing processing on the basis of various program and/or various parameters stored in the storage section 15.

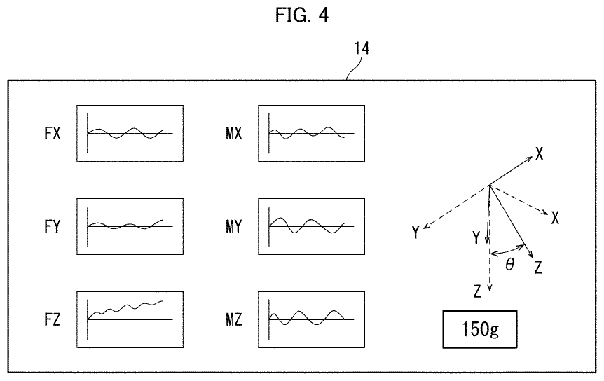

The manipulation section 12 is constituted by a plurality of button switches. By pressing a button switch, it is possible to carry out various kinds of operation such as turning-on/off of a power source and input of various instructions. The communication section 13 functions as an example of a communication interface for communicating with a personal computer (PC) and/or the like. The display 14 is made of, for example, a liquid crystal display or an organic electroluminescence (EL) display. For example, as shown in FIG. 4, the display 14 indicates force components, applied to the work piece W, in the force sensor coordinate system and the three coordinate axes.

The signal input section 16 is electrically connected to the force sensor 51, the triaxial acceleration sensor 52, and the triaxial gyro sensor 53. The signal input section 16 outputs, to the control section 11, detection values detected from detection signals respectively supplied from the force sensor 51, the triaxial acceleration sensor 52, and the triaxial gyro sensor 53. The control section 11 stores, in the storage section 15, the detection values of the force sensor 51, the triaxial acceleration sensor 52, and the triaxial gyro sensor 53, the detection values being supplied from the signal input section 16.

### [First Force Information Display Process]

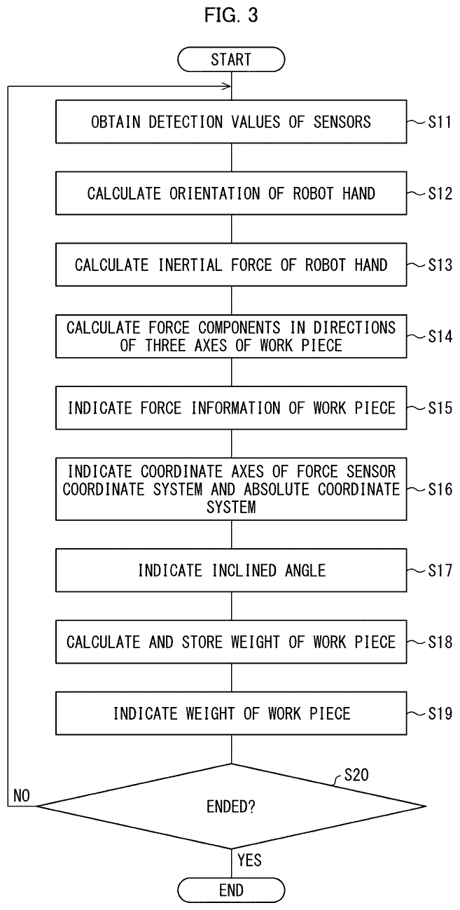

Next, the following will describe, with reference to FIGS. 3 and 4, an example of a first force information display process executed by the control section 11 of the force information display device 10 while teaching for the robot arm 30 is being conducted with the robot hand 40 holding the work piece W. FIG. 3 is a flowchart illustrating an example of the first force information display process executed by the control section 11 of the force information display device 10. FIG. 4 is a view illustrating an example of a display screen indicated on the display 14 of the force information display device 10. Note that a program of the first force information display process shown in FIG. 3 is stored in the storage section 15 in advance.

As shown in FIG. 3, in step S11, the control section 11 obtains the detection values of the force sensor 51, the triaxial acceleration sensor 52, and the triaxial gyro sensor 53 which detection values are supplied from the signal input section 16, and then the control section 11 advances to step S12.

Specifically, the control section 11 stores, in the storage section 15, (i) the force components FX, FY, and FZ in the directions of the three axes, namely, the X-, Y-, and Z-axes of the force sensor coordinate system and (ii) the moment components MX, MY, and MZ each being around a rotational axis which is one of the three axes, the force components FX, FY, and FZ and the moment components MX, MY, and MZ being supplied from the force sensor 51. The control section 11 stores, in the storage section 15, the acceleration components AX, AY, and AZ in the directions of the three axes, namely, the X-, Y-, and Z-axes of the force sensor coordinate system, the acceleration components AX, AY, and AZ being supplied from the triaxial acceleration sensor 52. The control section 11 stores, in the storage section 15, the angular velocity components WX, WY, and WZ each being around a rotational axis which is one of the three axes, namely, the X-, Y-, and Z-axes of the force sensor coordinate system, the angular velocity components WX, WY, and WZ being supplied from the triaxial gyro sensor 53.

In step S12, the control section 11 reads, from the storage section 15, the angular velocity components WX, WY, and WZ of the triaxial gyro sensor 53, each of the angular velocity components WX, WY, and WZ having a rotational axis of one of the three axes of the force sensor coordinate system. Then, the control section 11 calculates, from the read angular velocity components WX, WY, and WZ, a displaced angle of the robot hand 40, namely, a displaced orientation of the work piece W, and stores the result of calculation in the storage section 15.

Further, the control section 11 reads, from the storage section 15, the acceleration components AX, AY, and AZ of the triaxial acceleration sensor 52 in the directions of the three axes of the force sensor coordinate system. Then, the control section 11 calculates, from the read acceleration components AX, AY, and AZ, distances in which the robot hand 40 has moved in the directions of the three axes, namely, distances in which the work piece W has moved in the directions of the three axes, and stores the result of calculation in the storage section 15. Thereafter, the control section 11 advances to step S13.

In step S13, the control section 11 reads, from the storage section 15, a mass MH of the robot hand 40. The control section 11 sequentially reads, from the storage section 15, the acceleration components AX, AY, and AZ of the triaxial acceleration sensor 52 in the directions of the three axes of the force sensor coordinate system. Then, the control section 11 multiplies the acceleration components AX, AY, and AZ in the directions of the three axes by the mass MH of the robot hand 40 to yield inertial force components FAX, FAY, and FAZ of the robot hand 40 in the directions of the three axes of the force sensor coordinate system. The control section 11 stores, in the storage section 15, the inertial force components FAX, FAY, and FAZ of the robot hand 40 in the directions of the three axes of the force sensor coordinate system. Then, the control section 11 advances to step S14. Note that the mass MH of the robot hand 40 is stored in advance in the storage section 15.

In step S14, the control section 11 reads, from the storage section 15, (i) the force components FX, FY, and FZ in the directions of the three axes, namely, the X-, Y-, and Z-axes of the force sensor coordinate system, supplied from the force sensor 51, and (ii) the inertial force components FAX, FAY, and FAZ of the robot hand 40 in the directions of the three axes of the force sensor coordinate system. Then, the control section 11 respectively subtracts the inertial force components FAX, FAY, and FAZ in the directions of the three axes from the force components FX, FY, and FZ in the directions of the three axes, and stores, in the storage section 15, the results of subtraction as force components FX, FY, and FZ (modified forces) of the work piece W in the directions of the three axes, namely, the X-, Y-, and Z-axes of the force sensor coordinate system. Thereafter, the control section 11 advances to step S15.

In step S15, the control section 11 reads, from the storage section 15, the force components FX, FY, and FZ (modified forces) of the work piece W in the directions of the three axes, namely, the X-, Y-, and Z-axes of the force sensor coordinate system. Further, the control section 11 reads the moment components MX, MY, and MZ each being around a rotational axis which is one of the three axes, namely, the X-, Y-, and Z-axes of the force sensor coordinate system, the moment components MX, MY, and MZ being stored in the storage section 15 in step S11. Then, the control section 11 indicates, on the display 14, (i) the force components FX, FY, and FZ (modified forces) of the work piece W in the directions of the three axes, namely, the X-, Y-, and Z-axes of the force sensor coordinate system and (ii) the moment components MX, MY, and MZ each being around a rotational axis which is one of the three axes, namely, the X-, Y-, and Z-axes of the force sensor coordinate system. Thereafter, the control section 11 advances to step S16.

Note that the control section 11 may indicate, on the display 14, at least one component of (i) the force components FX, FY, and FZ (modified forces) of the work piece W in the directions of the three axes, namely, the X-, Y-, and Z-axes of the force sensor coordinate system and (ii) the moment components MX, MY, and MZ each being around a rotational axis which is one of the three axes, namely, the X-, Y-, and Z-axes of the force sensor coordinate system.

In step S16, the control section 11 indicates, on the display 14, the coordinate axes, namely, the X-, Y-, and Z-axes of the absolute coordinate system whose Z-axis direction coincides with the vertical direction. Further, the control section 11 reads the displaced orientation of the work piece W and the distances of movement of the work piece W in the directions of the three axes, each stored in step S12. Then, the control section 11 indicates, on the display 14, the coordinate axes, namely, the X-, Y-, and Z-axes of the force sensor coordinate system in such a manner that the Z-axis direction of the force sensor coordinate system matches the displaced orientation of the work piece W. Further, the control section 11 indicates, on the display 14, an origin of the coordinate axes, namely, the X-, Y-, and Z-axes of the force sensor coordinate system in such a manner that the origin overlaps an origin of the coordinate axes, namely, the X-, Y-, and Z-axes of the absolute coordinate system. Thereafter, the control section 11 advances to step S17.

In step S17, the control section 11 calculates an inclined angle θ of the Z-axis of the force sensor coordinate system with respect to the Z-axis of the absolute coordinate system, and indicates the result of calculation on the display 14. Thereafter, the control section 11 advances to step S18.

Here, the following will describe, with reference to FIG. 4, an example in which the display 14 indicates the force components of the work piece W in the force sensor coordinate system, the coordinate axes of the absolute coordinate system, and the coordinate axes of the force sensor coordinate system. As shown in FIG. 4, graphs indicating changes in the force components FX, FY, and FZ (modified forces) of the work piece W in the directions of the three axes, namely, the X-, Y-, and Z-axes of the force sensor coordinate system are indicated in a left portion of the screen such that the graphs are vertically aligned. Further, graphs indicating changes in the moment components MX, MY, and MZ of the work piece W each of which is around a rotational axis which is one of the three axes, namely, the X-, Y-, and Z-axes of the force sensor coordinate system are indicated at a location rightward of the graphs indicating the force components in the directions of the three axes. That is, the graphs indicating the changes in the moment components MX, MY, and MZ are indicated in a substantially center potion in a right-left direction of the screen such that the graphs are vertically aligned.

Further, the coordinate axes of the absolute coordinate system whose Z-axis direction coincides with the vertical direction are indicated by the broken lines and are arranged in a right portion of the screen. The coordinate axes, namely, the X-, Y-, and Z-axes of the force sensor coordinate system are indicated by the solid lines so as to overlap the coordinate axes of the absolute coordinate system in such a manner that the Z-axis direction of the force sensor coordinate system matches the displaced orientation of the work piece W. The origin of the coordinate axes of the force sensor coordinate system is indicated so as to overlap the origin of the coordinate axes of the absolute coordinate system. Further, the inclined angle θ of the Z-axis of the force sensor coordinate system with respect to the Z-axis of the absolute coordinate system is indicated.

With this, work a person can easily acknowledge the changes in (i) the force components FX, FY, and FZ of the work piece W in the directions of the three axes of the force sensor coordinate system and (ii) the moment components MX, MY, and MZ each being around a rotational axis which is one of the three axes. Further, the work person can easily acknowledge the inclined angle of the Z-axis direction of the work piece W with respect to the vertical direction. Note that the force components FX, FY, and FZ of the work piece W in the directions of the three axes of the force sensor coordinate system and the moment components MX, MY, and MZ each being around a rotational axis which is one of the three axes may be indicated by a numerical value, rather than by a graph.

Next, as shown in FIG. 3, in step S18, the control section 11 reads, from the storage section 15, the force components FX, FY, and FZ in the directions of the three axes, namely, the X-, Y-, and Z-axes of the force sensor coordinate system, the force components FX, FY, and FZ being supplied from the force sensor 51 and stored in step S11. The control section 11 calculates, from the force components FX, FY, and FZ of the directions of the three axes, namely, the X-, Y-, and Z-axes of the force sensor coordinate system, a resultant force F1 applied to the robot hand 40 and the work piece W, and stores the result of calculation in the storage section 15.

Subsequently, the control section 11 reads, from the storage section 15, the acceleration components AX, AY, and AZ in the directions of the three axes, namely, the X-, Y-, and Z-axes of the force sensor coordinate system, the acceleration components AX, AY, and AZ being supplied from the triaxial acceleration sensor 52 and stored in step S11. Then, the control section 11 calculates, from the acceleration components AX, AY, and AZ in the directions of the three axes, namely, the X-, Y-, and Z-axes of the force sensor coordinate system, a direction of movement of the robot hand 40 and the work piece W, that is, an acceleration A1 in a direction in which the force is applied to the robot hand 40 and the work piece W, and stores the result of calculation in the storage section 15.

Then, the control section 11 reads, from the storage section 15, the mass MH of the robot hand 40, and multiplies the mass MH of the robot hand 40 by the acceleration A1 in the direction of movement, so as to give an inertial force FH of the robot hand 40. Further, the control section 11 multiplies the mass MH of the robot hand 40 by a gravitational acceleration G, so as to give a weight MHG, which is a force of the robot hand 40 in a gravity direction.

Then, the control section 11 divides, by a value obtained by adding the gravitational acceleration G to the acceleration A1 in the direction of movement, a value obtained by subtracting a resultant force of the inertial force FH and the weight MHG of the robot hand 40 from the resultant force F1, so as to give a mass MW of the work piece MW. Then, the control section 11 stores the result of calculation in the storage section 15. Subsequently, the control section 11 multiplies the mass MW of the work piece W by the gravitational acceleration G, so as to give a weight MWG of the work piece W. Then, the control section 11 stores the result of calculation in the storage section 15. Thereafter, the control section 11 advances to step S19. With this, the control section 11 can measures the weight of the work piece W during conveyance of the work piece W.

In step S19, the control section 11 reads the weight MWG of the work piece W from the storage section 15, and indicates the weight MWG on the display 14. Then, the control section 11 advances to step S20. For example, as shown in FIG. 4, the control section 11 indicates the weight MWG of the work piece W at a location below the Z-axis of the absolute coordinate system.

In step S20, the control section 11 determines whether or not teaching for the robot arm 30 is ended. For example, the control section 11 determines whether or not an end button in the manipulation section 12 is pressed. If the control section 11 determines that teaching for the robot arm 30 is not ended (S20: NO), the control section 11 executes the processes in step S11 and its subsequent step(s) again. Meanwhile, if the control section 11 determines that teaching for the robot arm 30 is ended (S20: YES), the control section 11 ends the first force information display process.

As discussed in detail above, according to the force information display device 10 in accordance with the first embodiment, the three coordinate axes of the absolute coordinate system and the three coordinate axes of the force sensor coordinate system are indicated on the display 14. With this, a work person can easily acknowledge, from the orientation of the Z-axis of the force sensor coordinate system with respect to the Z-axis of the absolute coordinate system and the inclined angle θ indicated on the display, an angle of a distal end of the robot arm with respect to the vertical direction during the work. Further, the work person can easily acknowledge, from the force components (modified forces) of the work piece W in the directions of the three axes of the force sensor coordinate system and the moment components around the three axes indicated on the display 14, a force of the distal end of the robot arm 30 applied to the work piece during the work.

Furthermore, the control section 11 can measure a weight of the work piece W during conveyance of the work piece W. Thus, the control section 11 can indicate, on the display 14, the weight MWG of the work piece W during conveyance of the work piece W. Therefore, even during conveyance of the work piece W, the work person can acknowledge the weight MWG of the work piece W in real time.

### Second Embodiment

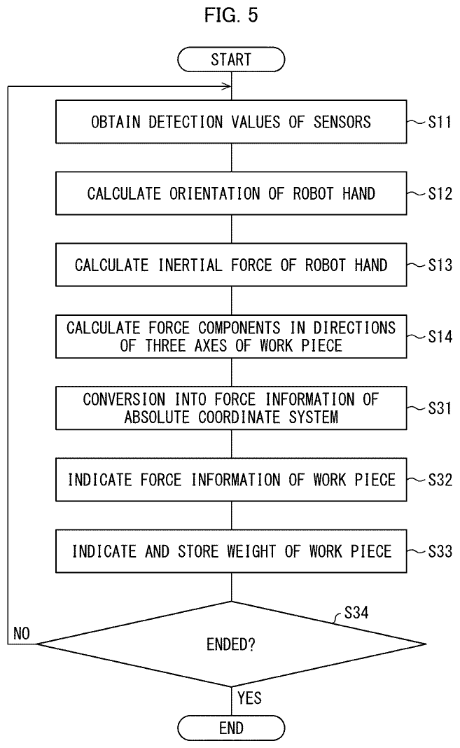

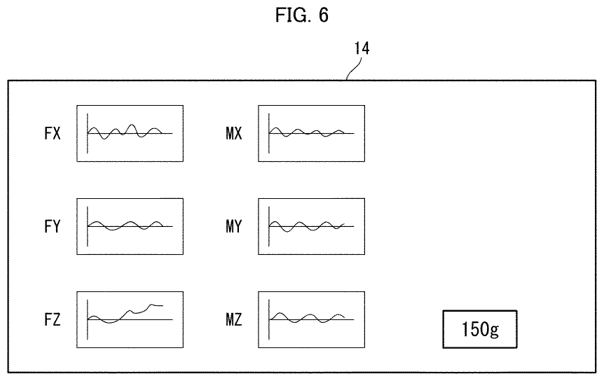

Next, the following description will discuss, with reference to FIGS. 5 and 6, the second embodiment of the present disclosure. FIG. 5 is a flowchart illustrating an example of a second force information display process executed by the control section 11 in accordance with the second embodiment. FIG. 6 is a view illustrating an example of a display screen indicated on the display 14 of the force information display device 10 in accordance with the second embodiment. Note that, for convenience, members having identical functions to those of the first embodiment are given identical reference signs, and their descriptions will be omitted.

### [Second Force Information Display Process]

The control section 11 of the force information display device 10 in accordance with the second embodiment executes the second force information display process shown in FIG. 5, instead of the first force information display process shown in FIG. 3. Note that a program of the second force information display process shown in FIG. 5 is stored in advance in the storage section 15.

As shown in FIG. 5, after the control section 11 executes the processes in steps S11 to S14, the control section 11 advances to step S31. In step S31, the control section 11 reads, from the storage section 15, the force components FX, FY, and FZ of the work piece W in the directions of the three axes, namely, the X-, Y-, and Z-axes of the force sensor coordinate system. Further, the control section 11 reads the moment components MX, MY, and MZ each being around a rotational axis of one of the three axes, namely, the X-, Y-, and Z-axes of the force sensor coordinate system, the moment components MX, MY, and MZ being stored in the storage section 15 in step S11.

Further, the control section 11 reads, from the storage section 15, the displaced orientation of the work piece W and the distances of movement of the work piece W in the directions of the three axes calculated in step S12, and stores these pieces of information in the storage section 15 as displacement information of the work piece W. Then, on the basis of the displacement information of the work piece W, the control section 11 carries out conversion such that the force components of the work piece W in the directions of the three axes of the force sensor coordinate system and the moment components each being around a rotational axis of one of the three axes are respectively converted into force components of the work piece W in the directions of the three axes of the absolute coordinate system and moment components each being around a rotational axis of one of the three axes of the absolute coordinate system. Then, the control section 11 stores, in the storage section 15, the force components of the work piece W in the directions of the three axes of the absolute coordinate system and the moment components each being around a rotational axis of one of the three axes of the absolute coordinate system obtained as a result of the conversion. Thereafter, the control section 11 advances to step S32.

In step S32, the control section 11 reads, from the storage section 15, the force components of the work piece W in the directions of the three axes of the absolute coordinate system and the moment components each being around a rotational axis of one of the three axes of the absolute coordinate system, and indicates, on the display 14, the pieces of information thus read. Then, the control section 11 advances to step S33.

In step S33, the control section 11 executes the processes in steps S18 and S19 to calculate a weight MWG of the work piece W and store the weight MWG in the storage section 15, and then indicates the weight MWG of the work piece W on the display 14. Thereafter, the control section 11 advances to step S34.

Here, the following will describe, with reference to FIG. 6, an example in which the display 14 indicates the force components of the work piece W in the absolute coordinate system and the weight MWG of the work piece W. As shown in FIG. 6, graphs indicating changes in the force components FX, FY, and FZ of the work piece W in the directions of the three axes, namely, the X-, Y-, and Z-axes of the absolute coordinate system are indicated in a left portion of the screen such that the graphs are vertically aligned.

Further, graphs indicating changes in the moment components MX, MY, and MZ of the work piece W each of which is around a rotational axis which is one of the three axes, namely, the X-, Y-, and Z-axes of the absolute coordinate system are indicated at a location rightward of the graphs indicating the force components in the directions of the three axes. That is, the graphs indicating the changes in the moment components MX, MY, and MZ are indicated in a substantially center potion in a right-left direction of the screen such that the graphs are vertically aligned. Then, the weight MWG of the work piece W is indicated in a right portion of the screen.

With a work this, person can easily acknowledge the changes in (i) the force components FX, FY, and FZ of the work piece W in the directions of the three axes of the absolute coordinate system and (ii) the moment components MX, MY, and MZ each being around a rotational axis which is one of the three axes of the absolute coordinate system. Further, the work person can easily acknowledge the weight MWG of the work piece W.

Note that the force components FX, FY, and FZ of the work piece W in the directions of the three axes of the absolute coordinate system and the moment components MX, MY, and MZ each being around a rotational axis which is one of the three axes of the absolute coordinate system may be indicated by a numerical value, rather than by a graph. Further, the control section 11 may simultaneously indicate, on the display 14, (i) the force components FX, FY, and FZ of the work piece W in the directions of the three axes, namely, the X-, Y-, and Z-axes of the force sensor coordinate system and (ii) the moment components MX, MY, and MZ each being around a rotational axis of one of the three axes, namely, the X-, Y-, and Z-axes of the force sensor coordinate system.

Next, as shown in FIG. 5, in step S34, the control section 11 determines whether or not teaching for the robot arm 30 is ended. For example, the control section 11 determines whether or not an end button in the manipulation section 12 is pressed. Then, if the control section 11 determines that teaching for the robot arm 30 is not ended (S34: NO), the control section 11 executes the processes in step S11 and its subsequent steps again. Meanwhile, if the control section 11 determines that teaching for the robot arm 30 is ended (S34: YES), the control section 11 ends the second force information display process.

As discussed in detail above, according to the force information display device 10 in accordance with the second embodiment, the force components in the directions of the three axes of the absolute coordinate system and the moment components around the three axes of the absolute coordinate system are indicated on the display 14. Thus, a work person can easily acknowledge the force components in the directions of the three axes of the absolute coordinate system and the moment components around the three axes of the absolute coordinate system, the force components and the moment components being applied to the work piece W.

Further, the control section 11 can measure a weight of the work piece W during conveyance of the work piece W. Thus, the control section 11 can indicate the weight MWG of the work piece W on the display 14 during conveyance of the work piece W. Therefore, even during conveyance of the work piece W, the work person can acknowledge the weight MWG of the work piece W in real time.

### [First Variation]

In the first embodiment and the second embodiment discussed above, the triaxial acceleration sensor 52 and the triaxial gyro sensor 53 may be integrated into a single sensor. Alternatively, the force sensor 51, the triaxial acceleration sensor 52, and the triaxial gyro sensor 53 may be integrated into a single sensor. The force sensor 51, the triaxial acceleration sensor 52, and the triaxial gyro sensor 53 may be integrated together or may be partially separated from each other. With this, it is possible to reduce the number of components.

### [Supplementary Note]

The present disclosure is not limited to the embodiment and modification examples described above, but can be altered by a skilled person in the art within the scope of the claims. The present disclosure also encompasses in its technical scope any embodiment based on an appropriate combination of the technical means disclosed in different embodiment and modification examples.

### [Supplementary Remarks]

A force information display device in accordance with a first aspect includes: a signal input section that receives detection signals respectively supplied from a force sensor and a gyro sensor disposed between a robot arm and a robot hand; and a control section, the control section executing a first calculation process and a first display process or a second display process, the first calculation process calculating a displaced angle of the robot hand from an angular velocity supplied from the gyro sensor via the signal input section, the first display process (a) carrying out, on a basis of the displaced angle of the robot hand calculated in the first calculation process, conversion such that at least one of a force and a moment in a force sensor coordinate system fixed to the force sensor, supplied from the force sensor via the signal input section, is converted into at least one of a force and a moment in an absolute coordinate system fixed to a ground and (b) indicating a result of the conversion on a display, and the second display process indicating, on the display, a relation between the absolute coordinate system and the force sensor coordinate system on a basis of the displaced angle of the robot hand calculated in the first calculation process.

According to the force information display device of the first aspect, the display indicates (i) at least one of the force and the moment in the absolute coordinate system or (ii) the relation between the absolute coordinate and system the force sensor coordinate system. Thus, a work person can easily acknowledge at least one of the force and the moment, applied to a work piece, in the absolute coordinate system.

A second aspect may be the force information display device in accordance with the first aspect configured such that, in the second display process, the control section further indicates, on the display, an inclined angle of the force sensor coordinate system with respect to the absolute coordinate system.

According to the force information display device of the second aspect, the display indicates the inclined angle of the force sensor coordinate system with respect to the absolute coordinate system. Thus, the work person can easily acknowledge an angle of a distal end of the robot arm with respect to a vertical direction during the work.

A third aspect may be the force information display device in accordance with the first or second aspect configured such that, in the second display process, the control section further indicates, on the display, at least one of the force and the moment in the force sensor coordinate system, the force and the moment being supplied from the force sensor via the signal input section.

According to the force information display device of the third aspect, the work person can easily acknowledge, from the force or moment, applied to the work piece and indicated on the display, in the force sensor coordinate system, a force of the distal end of the robot arm applied to the work piece during the work.

A fourth aspect may be the force information display device in accordance with the third aspect configured such that, the force information display device further includes: an acceleration sensor; and a storage section in which a mass of the robot hand is stored in advance, wherein, in the second display process, the control section further (a) calculates, from an acceleration supplied from the acceleration sensor via the signal input section and the mass of the robot hand, an inertial force of the robot hand in the force sensor coordinate system, and (b) indicates, on the display, a modified force obtained by subtracting the inertial force from the force in the force sensor coordinate system.

According to the force information display device of the fourth aspect, the display indicates the modified force, applied to the work piece, in the force sensor coordinate system. Thus, the work person can easily acknowledge the modified force, applied to the work piece, in the force sensor coordinate system.

A fifth aspect may be the force information display device in accordance with the fourth aspect configured such that, the control section executes a second calculation process and a third calculation process, the second calculation process calculating a mass of a work piece held by the robot hand, on a basis of the modified force, an acceleration in a direction of application of the modified force which acceleration is detected by the acceleration sensor, and a gravitational acceleration, and the third calculation process calculating a weight of the work piece by multiplying the mass of the work piece by the gravitational acceleration.

According to the force information display device of the fifth aspect, it is possible to measure the weight of the work piece during conveyance of the work piece. As a result, even during conveyance of the work piece, the work person can acknowledge the weight of the work piece in real time.

A sixth aspect may be the force information display device in accordance with the first aspect configured such that the force information display device further includes: an acceleration sensor; and a storage section in which a mass of the robot hand is stored in advance, wherein, in the first display process, the control section further executes a fourth calculation process, a fifth calculation process, and a first conversion process, the fourth calculation process calculating, from an acceleration supplied from the acceleration sensor via the signal input section and the mass of the robot hand, an inertial force of the robot hand in the force sensor coordinate system, the fifth calculation process calculating a modified force by subtracting the inertial force from the force in the force sensor coordinate system, and the first conversion process carrying out conversion to give a force or a moment in the absolute coordinate system, on a basis of at least one of the modified force and the moment in the force sensor coordinate system and the displaced angle of the robot hand calculated in the first calculation process, and the control section indicates, on a display, the force or the moment in the absolute coordinate system obtained by the conversion carried out in the first conversion process.

According to the force information display device of the sixth aspect, the display indicates the force or the moment, applied to the work piece, in the absolute coordinate system. Thus, the work person can easily acknowledge the force or the moment, applied to the work piece, in the absolute coordinate system.

A seventh aspect may be the force information display device in accordance with the sixth aspect configured such that the control section executes a sixth calculation process and a seventh calculation process, the sixth calculation process calculating a mass of a work piece held by the robot hand, on a basis of the modified force, an acceleration in a direction of application of the modified force which acceleration is detected by the acceleration sensor, and a gravitational acceleration, and the seventh calculation process calculating a weight of the work piece by multiplying the mass of the work piece by the gravitational acceleration.

According to the force information display device of the seventh aspect, it is possible to measure the weight of the work piece during conveyance of the work piece. As a result, even during conveyance of the work piece, the work person can acknowledge the weight of the work piece in real time.

A force information display device in accordance with an eighth aspect includes: a signal input section that receives detection signals respectively supplied from a force sensor, a gyro sensor, and an acceleration sensor disposed between a robot arm and a robot hand; a storage section in which a mass of the robot hand is stored in advance; and a control section, the control section executing a first calculation process, a second calculation process, a third calculation process, and a conversion process, the first calculation process calculating a displaced angle of the robot hand from an angular velocity supplied from the gyro sensor via the signal input section, the second calculation process calculating, from an acceleration supplied from the acceleration sensor via the signal input section and the mass of the robot hand, an inertial force of the robot hand in the force sensor coordinate system fixed to the force sensor, the third calculation process calculating a modified force by subtracting the inertial force from the force in the force sensor coordinate system supplied from the force sensor via the signal input section, and the conversion process carrying out, on a basis of the displaced angle of the robot hand calculated in the first calculation process, conversion such that the modified force in the force sensor coordinate system calculated in the third calculation process is converted into a force in an absolute coordinate system fixed to a ground.

According to the force information display device of the eighth aspect, the force information display device can calculate the force, applied to the work piece, in the absolute coordinate system. As a result, the force information display device can indicate, on the display, the force, applied to the work piece, in the absolute coordinate system. Thus, the work person can easily acknowledge the force, applied to the work piece, in the absolute coordinate system.

1. A force information display device comprising:
a signal input section that receives detection signals respectively supplied from a force sensor and a gyro sensor disposed between a robot arm and a robot hand; and
a control section,
the control section executing a first calculation process and a first display process or a second display process,
the first calculation process calculating a displaced angle of the robot hand from an angular velocity supplied from the gyro sensor via the signal input section,
the first display process (a) carrying out, on a basis of the displaced angle of the robot hand calculated in the first calculation process, conversion such that at least one of a force and a moment in a force sensor coordinate system fixed to the force sensor, supplied from the force sensor via the signal input section, is converted into at least one of a force and a moment in an absolute coordinate system fixed to a ground and (b) indicating a result of the conversion on a display, and
the second display process indicating, on the display, a relation between the absolute coordinate system and the force sensor coordinate system on a basis of the displaced angle of the robot hand calculated in the first calculation process.

2. The force information display device according to claim 1, wherein:
in the second display process, the control section further indicates, on the display, an inclined angle of the force sensor coordinate system with respect to the absolute coordinate system.

3. The force information display device according to claim 1, wherein:
in the second display process, the control section further indicates, on the display, at least one of the force and the moment in the force sensor coordinate system, the force and the moment being supplied from the force sensor via the signal input section.

4. The force information display device according to claim 2, wherein:
in the second display process, the control section further indicates, on the display, at least one of the force and the moment in the force sensor coordinate system, the force and the moment being supplied from the force sensor via the signal input section.

5. The force information display device according to claim 3, further comprising:
an acceleration sensor; and
a storage section in which a mass of the robot hand is stored in advance, wherein
in the second display process, the control section further (a) calculates, from an acceleration supplied from the acceleration sensor via the signal input section and the mass of the robot hand, an inertial force of the robot hand in the force sensor coordinate system, and (b) indicates, on the display, a modified force obtained by subtracting the inertial force from the force in the force sensor coordinate system.

6. The force information display device according to claim 4, further comprising:
an acceleration sensor; and
a storage section in which a mass of the robot hand is stored in advance, wherein
in the second display process, the control section further (a) calculates, from an acceleration supplied from the acceleration sensor via the signal input section and the mass of the robot hand, an inertial force of the robot hand in the force sensor coordinate system, and (b) indicates, on the display, a modified force obtained by subtracting the inertial force from the force in the force sensor coordinate system.

7. The force information display device according to claim 5, wherein:
the control section executes a second calculation process and a third calculation process,
the second calculation process calculating a mass of a work piece held by the robot hand, on a basis of the modified force, an acceleration in a direction of application of the modified force which acceleration is detected by the acceleration sensor, and a gravitational acceleration, and
the third calculation process calculating a weight of the work piece by multiplying the mass of the work piece by the gravitational acceleration.

8. The force information display device according to claim 6, wherein:
the control section executes a second calculation process and a third calculation process,
the second calculation process calculating a mass of a work piece held by the robot hand, on a basis of the modified force, an acceleration in a direction of application of the modified force which acceleration is detected by the acceleration sensor, and a gravitational acceleration, and
the third calculation process calculating a weight of the work piece by multiplying the mass of the work piece by the gravitational acceleration.

9. The force information display device according to claim 1, further comprising:
an acceleration sensor; and
a storage section in which a mass of the robot hand is stored in advance, wherein
in the first display process, the control section further executes a fourth calculation process, a fifth calculation process, and a first conversion process, the fourth calculation process calculating,
from an acceleration supplied from the acceleration sensor via the signal input section and the mass of the robot hand, an inertial force of the robot hand in the force sensor coordinate system,
the fifth calculation process calculating a modified force by subtracting the inertial force from the force in the force sensor coordinate system, and
the first conversion process carrying out conversion to give a force or a moment in the absolute coordinate system, on a basis of at least one of the modified force and the moment in the force sensor coordinate system and the displaced angle of the robot hand calculated in the first calculation process, and
the control section indicates, on a display, the force or the moment in the absolute coordinate system obtained by the conversion carried out in the first conversion process.

10. The force information display device according to claim 9, wherein:
the control section executes a sixth calculation process and a seventh calculation process,
the sixth calculation process calculating a mass of a work piece held by the robot hand, on a basis of the modified force, an acceleration in a direction of application of the modified force which acceleration is detected by the acceleration sensor, and a gravitational acceleration, and
the seventh calculation process calculating a weight of the work piece by multiplying the mass of the work piece by the gravitational acceleration.
